(19) United States
(12) Patent Application Publication
(10) Pub. No.: US 2024/0175111 A1
(43) Pub. Date: May 30, 2024

(54) HIGH-STRENGHT AND HIGHT DUCTILITY STAINLESS STEEL BY ADDITIVE MANUFACTURING AND METHOD OF PREPARING THE SAME

(71) Applicant: UNIVERSITY OF SCIENCE AND TECHNOLOGY BEIJING, Beijing (CN)

(72) Inventors: Chaofang DONG, Beijing (CN); Li WANG, Beijing (CN); Decheng KONG, Beijing (CN); Shiyuan ZHANG, Beijing (CN); Yucheng JI, Beijing (CN); Xiaogang LI, Beijing (CN)

(21) Appl. No.: 18/179,362

(22) Filed: Mar. 7, 2023

(30) Foreign Application Priority Data
Jul. 5, 2022 (CN) 202210781652.8

(51) Int. Cl. C22C 33/02; B22F 10/28; B22F 10/64; B33Y 10/00; B33Y 40/20; B33Y 70/00; B33Y 80/00; C22C 38/02; C22C 38/04; C22C 38/42; C22C 38/48

(52) U.S. Cl. CPC C22C 33/0207; B22F 10/28; B22F 10/64; B33Y 10/00; B33Y 40/20; B33Y 70/00; B33Y 80/00; C22C 33/0285; C22C 38/02; C22C 38/04; C22C 38/42; C22C 38/48; B22F 2201/02; B22F 2301/35; B22F 2998/10; B22F 2999/00

(57) ABSTRACT

An additively manufactured high-strength and high-ductility stainless steel is characterized in that the composition, by weight percentage, C≤0.05 wt %, Si≤1 wt %, Mn≤1 wt %, Cr 14.5-15.5 wt %, Ni 5.0-5.5 wt %, Cu 4-4.5 wt %, Nb 0.35-0.45 wt %, and the balance of Fe and unavoidable impurities. And Cr equivalent of Cr_{eq}=% Cr+% Mo+2.2% Ti+0.7% Nb+2.48% Al. Ni equivalent of Ni_{eq}=% Ni+35% C+20% N+0.25% Cu. The yield strength of the high-strength and high-ductility stainless steel ≥1270 MPa, the tensile strength ≥1380 MPa, and the elongation after fracture ≥15%.

### CROSS REFERENCE TO RELATED APPLICATIONS

The present application claims priority to Chinese Patent Application No. 202210781652.8, entitled “HIGH-STRENGTH AND HIGH DUCTILITY STAINLESS STEEL BY ADDITIVE MANUFACTURING AND METHOD OF PREPARING THE SAME,” filed Aug. 5, 2022, in the China National Intellectual Property Administration (CNIPA), the entire of which is hereby incorporated in its entirety by reference.

### FIELD OF THE DISCLOSURE

The invention relates to the technical field of additive manufacturing of metals, specifically, an additive manufacturing of high-strength and high-ductility stainless steel and its preparation process.

### BACKGROUND OF THE DISCLOSURE

With the rapid development of aerospace and ocean engineering, equipment structural parts are more and more complex and the service environment is gradually severe, so that high-performance and high-strength stainless steel components more and more demand. The service performance of the high-strength martensitic stainless steel is closely related to the microstructure, and its higher strength is mainly contributed to ultrahigh-density dislocation and nano-scale precipitated phase of a martensitic matrix. The plasticity and ductility of the high-strength martensitic stainless steel are continuously optimized mainly by improving the distribution and the content of austenite. However, the increase of either strength and plasticity will lead to the decrease of another property, which is called the strength-ductility trade off. Therefore, it is necessary to optimize its microstructure and service performance with the help of a new preparation process.

Additive manufacturing technology, also known as 3D printing, is a rapidly developing emerging process in recent years. With the additive manufacturing technology, components with complex structures, which are difficult or impossible to be produced with traditional processes, can be manufactured quickly and accurately with simpler production process. At the same time, the raw materials can be saved and the development cycle can be significantly shortened. The additive manufacturing has the characteristics of high laser energy, rapid cooling, and multi-pass circulating heat treatment, etc. Therefore, the additive manufacturing stainless steel has an obvious molten pool structure, and the prepared structural part has the characteristics of uneven stress distribution, multiple interfaces and fine microstructure.

The high-strength stainless steel printed at present has a fine microstructure, nano-scale oxide inclusions, and obvious molten pool interface. Tensile experiments show that the mechanical properties of the martensitic stainless steel fabricated by the additive manufacturing are comparable to those of conventional fabrication, but the microstructure phase distribution is significantly different. Therefore, it is of great importance to develop a stainless steel with controlled microstructure and simultaneous enhancement of strength and ductility.

### SUMMARY OF THE DISCLOSURE

The invention mainly aims to provide an additively manufactured high-strength and high-ductility stainless steel and its preparation process to overcome the contradiction relationship of strength-ductility inversion. By optimizing the alloy composition, the phase diagram relationship between alloy composition and structure is established for the additively manufactured stainless steel. The multi-scale multiple heterostructure high-strength martensitic stainless steels are prepared by the fast cooling and high-energy laser features of additive manufacturing. The strength and elongation for the additively manufactured heterostructure martensitic stainless steel are significantly higher than those of conventionally fabricated stainless steels with similar compositions.

To solve the above technical problem, according to an aspect of the present invention, the present invention provides the following technical solutions:

An additively manufactured high-strength and high-ductility stainless steel with a composition of, by weight percentage, C≤0.05 wt %, Si≤1 wt %, Mn≤1 wt %, Cr 14.5-15.5 wt %, Ni 5.0-5.5 wt %, Cu 4-4.5 wt %, Nb 0.35-0.45 wt %, and the balance of Fe and unavoidable impurities.
And Cr equivalent Cr_{eq}=% Cr+% Mo+2.2% Ti+0.7% Nb+2.48% Al
Ni equivalent of Ni_{eq}=% Ni+35% C+20% N+0.25% Cu

The yield strength of the high-strength and high-ductility stainless steel ≥1270 MPa, the tensile strength ≥1380 MPa, and the elongation after fracture ≥15%.

The microstructure of high-strength and high-ductility stainless steel comprises bulk austenite distributed at the bottom of a molten pool and thin-film austenite formed among martensite laths, and a high-density nano-scale multiple precipitated phases is precipitated in a fine martensite lath matrix. The high content of austenite improves the ductility and ductility of the stainless steel, and the high-density nano-scale multiple precipitates in the fine martensite lath matrix to further improve the tensile strength of the stainless steel.

The preferable scheme for an additively manufactured high-strength and high-ductility stainless steel is as follows: the Cr equivalent Cr_{eq} is 13.8-15.4 and Ni equivalent Ni_{eq} is 7.5-8.8. More preferably, the Cr equivalent Cr_{eq} is 14.5-15.0, the Ni equivalent Ni_{eq} is 7.8-8.4.

The preferable scheme for an additively manufactured high-strength and high-ductility stainless steel is as follows: the yield strength of the high-strength and high-ductility stainless steel ≥1300 MPa, the tensile strength ≥1440 MPa, and the elongation after fracture ≥16%.

In order to solve the above technical problem, according to another aspect of the present invention, the present invention provides the following technical solutions:

A preparation process for manufacturing high-strength and high-ductility stainless steel by additive manufacturing comprises the following steps:
S1, taking the stainless-steel powders of the components for standby;
S2, printing the powder described in the step S1 by adopting a 3D printing process to form a printed product;
S3, carrying out heat treatment on the printed product formed in the step S2.

As a preferred scheme of the preparation process for the additive manufacturing of the high-strength and high-ductility stainless steel, the method comprises the following steps: in the step S1, the stainless-steel powder has a particle size of 15-45 μm.

As a preferred scheme of the preparation process for the additive manufacturing of the high-strength and high-ductility stainless steel, the method comprises the following steps: In step S2, the parameters of the 3D printing process are: the diameter of the laser spot is 100-300 μm, the laser power is 230-400 W, the scanning interval is 0.07-0.10 mm, the scanning speed is 550-900 mm/s, and the powder spreading thickness is 0.02-0.04 mm. the density of the printed product can reach more than 97%.

As a preferred scheme of the preparation process for the additive manufacturing the high-strength and high-ductility stainless steel, the method comprises the following steps: In the step S3, the heating rate of the heat treatment is 6-10° C./min until the temperature is increased to 450-500° C., and holding for 2-10 h.

The invention has the following beneficial effects:

The present invention proposes an additively manufactured high-strength and high-ductility stainless steel and its preparation process. Firstly, the phase diagram of the relationship between different alloy compositions and phase composition for additive manufacturing stainless steel is established. After that, the new alloy composition is optimized in the martensitic-austenitic duplex region by alloy composition design and optimization of austenite forming element content. Finally, the periodically distributed heterogeneous structured martensitic stainless steel with yield strength ≥1270 MPa, tensile strength ≥1380 MPa, and elongation after fracture ≥15% were prepared by means of additive manufacturing. Compared with traditional martensitic stainless-steel materials of similar composition, the high strength and high plasticity are simultaneously improved, breaking the trade-off of the strength and the plasticity of traditional martensitic stainless steel of the similar composition

### BRIEF DESCRIPTION OF DRAWINGS

In order to more clearly illustrate the embodiments of the present invention or the technical solutions in the prior art, the drawings used in the description of the embodiments or the prior art will be briefly described below. It is obvious that the drawings in the following description are only some embodiments of the present invention, and for those skilled in the art, other drawings can be obtained according to the structures shown in the drawings without creative efforts.

FIG. 1 shows the relationship between the phase composition and Cr equivalents and Ni equivalents of the stainless steel made by the additive manufacturing of the present invention.

FIG. 2 shows the microstructure of stainless steel according to embodiment 1 of the present invention;

FIG. 3 shows the room temperature tensile test results of stainless steel for each embodiment and comparative embodiment of the present invention.

FIG. 4 shows the relationship between the strength and ductility of embodiment 1 and comparative embodiment 2 of the present invention.

The realization of the purpose, functional features and advantages of the present invention will be further described with reference to the accompanying drawings in conjunction with the embodiments.

### DETAILED DESCRIPTION OF THE DISCLOSURE

The following will clearly and completely describe the technical solutions in the embodiments, and it is obvious that the described embodiments are only a part of the embodiments of the present invention, and not all embodiments. Based on the embodiments in the present invention, all other embodiments obtained without creative labor by a person of ordinary skill in the art fall within the scope of protection of the present invention.

The present invention provides an additive manufacturing high-strength and high-ductility stainless steel and its preparation process, which can break the inverse contradiction of the strength-ductility of the traditional martensitic stainless steel of the similar composition, and realize the simultaneous improvement of high strength and high ductility. Firstly, the phase diagram of the relationship between different alloy compositions and phase composition for additive manufacturing stainless steel is established. After that, the new alloy composition is optimized in the martensitic-austenitic duplex region by alloy composition design and optimization of austenite forming element content. Finally, the periodically distributed heterogeneous structured martensitic stainless steel with yield strength ≥1270 MPa, tensile strength ≥1380 MPa, and elongation after break ≥15% were prepared by means of additive manufacturing.

According to one aspect of the invention, the invention provides the following technical scheme:

An additively manufactured high-strength and high-ductility stainless steel with a composition of, by weight percentage, C≤0.05 wt %, Si≤1 wt %, Mn≤1 wt %, Cr 14.5-15.5 wt %, Ni 5.0-5.5 wt %, Cu 4-4.5 wt %, Nb 0.35-0.45 wt %, and the balance of Fe and unavoidable impurities.
And Cr equivalent Cr_{eq}=% Cr+% Mo+2.2% Ti+0.7% Nb+2.48% Al
Ni equivalent of Ni_{eq}=% Ni+35% C+20% N+0.25% Cu

The Cr equivalent Cr_{eq} is 13.8-15.4 and Ni equivalent Ni_{eq} is 7.5-8.8. More preferably, the Cr equivalent Cr_{eq} is 14.5-15.0, the Ni equivalent Ni_{eq} is 7.8-8.4.

Specifically, the Cr equivalent Cr_{eq} is, for example, but not limited to, any one of 14.5, 14.6, 14.7, 14.8, 14.9, 15.0 or a range between any two. Specifically, the Ni equivalent Ni_{eq} is, for example, but not limited to, any one of 7.8, 7.9, 8.0, 8.1, 8.2, 8.3, 8.4 or a range between any two.

The present invention is based on the study of the formation mechanism of the phase composition of stainless steel and the optimization of austenite forming elements compared to the conventional similar composition 15-5PH stainless steel. The stainless steel of the present invention has a higher content of Ni and Cu elements, resulting in a higher Ni equivalent Ni_{eq}, which allows this alloy composition stainless steel to be shifted from the martensitic region to the martensitic-austenitic duplex region of the phase diagram of the additive manufactured stainless steel in order to obtain a periodically distributed martensitic stainless steel. Meanwhile, the main chemical composition of Cr, Ni, Nb and Cu ratios in this composition can be designed to meet the formation of high-density precipitation phase, thus simultaneously improving its strength and ductility.

The microstructure of high-strength and high-ductility stainless steel comprises bulk austenite distributed at the bottom of a molten pool and thin-film austenite formed among martensite laths, and a high-density nano-scale multiple precipitated phases is precipitated in the fine martensite lath matrix. The high content of austenite improves the ductility of the stainless steel, and the high-density nano-scale multiple precipitated phases is precipitated in the fine martensite lath matrix to further improve the tensile strength of the stainless steel.

The microstructure matrix of additively manufactured high-strength and high-ductility stainless steel is mainly martensite, which contains more than 20% austenite. The size of high-density nanoscale multiple precipitation phase is 1-3 nm, with an average size of about 1.5 nm.

The yield strength of the high-strength and high-ductility stainless steel ≥1270 MPa, the tensile strength ≥ to 1380 MPa, and the elongation after fracture ≥15%. Preferably, the yield strength of the high-strength and high-ductility stainless steel ≥1300 MPa, the tensile strength ≥1440 MPa, and the elongation after fracture ≥16%.

According to another aspect of the invention, the invention provides the following technical scheme:

A preparation process for high-strength and high-ductility stainless steel by additive manufacturing comprises the following steps:
S1, taking the stainless steel powders of the components for standby;
S2, printing the powders obtained in the step S1 by adopting a 3D printing process to form a printed product;
S3, carrying out heat treatment on the printed product formed in the step S2.

The present invention establishes the phase diagram relationship between alloy composition and microstructure for additively manufactured stainless steel. By optimizing the alloy composition, the multi-scale multiple heterostructure high-strength stainless steel is prepared with the features of rapid cooling and high-energy laser in additive manufacturing. The strength and elongation after fracture of this additively manufactured heterostructure stainless steel are significantly higher than those of conventionally fabricated stainless steels with similar compositions.

The size of powders is 15-45 μm. Specifically, the size of powder particles is, for example, but not limited to, a range between any two of 15 μm, 20 μm, 25 μm, 30 μm, 35 μm, 40 μm, and 45 μm. The powders are free of hollow powder and the sphericity is greater than or equal to 95%. There were no inclusion and the particle size distribution of the powder is as follows: D10: 19.3%, D50: 30.9%, D90: 49.2%.

The parameters of the 3D printing process are as follows: the diameter of the laser spot is 100-300 μm, laser power 230-400 W, scanning pitch 0.07-0.10 mm, scanning speed 550-900 mm/s, powder thickness 0.02-0.04 mm, protective atmosphere is nitrogen. The densities of the printed products can reach more than 97%.

The 3D printing process parameters can be adjusted according to the particle size and composition of the raw material to be printed. And specifically, the spot diameter is, for example, but not limited to, any one of 100 μm, 150 μm, 200 μm, 250 μm, and 300 μm, or a range between any two of them. The laser power is, for example, but not limited to, any one of 230 W. 250 W, 300 W. 400 W, or a range between any two. The scan pitch is, for example, but not limited to, any one of 0.07 mm. 0.08 mm, 0.09 mm, 0.10 mm, or a range between any two. The scanning speed is, for example, but not limited to, any one of 550 mm/s, 600 mm/s, 650 mm/s, 700 mm/s, 750 mm/s, 800 mm/s, 850 mm/s, 900 mm/s or a range between any two. The powder thickness is, for example, but not limited to, any one of 0.02 mm, 0.025 mm, 0.03 mm, 0.035 mm, 0.04 mm, or a range between any two.

The heating rate of the heat treatment is 6-10° C./min until the temperature is increased to 450° C. and 500° C., and hold for 2-10 h. The heat treatment process parameters can be adjusted according to the composition of the printing raw materials, and specifically, the heating rate is, for example, but not limited to, any one of 6° C./min, 7° C./min, 8° C./min, 9° C./min, 10° C./min or a range between any two. The heat treatment temperature is, for example, but not limited to, any one of 450° C., 460° C., 470° C., 480° C., 490° C., 500° C. or a range between any two. The holding time is, for example, but not limited to, 2 h, 3 h, 4 h, 5 h, 6 h, 7 h, 8 h, 9 h, 10 h.

### Embodiment 1

A high-strength and high-ductility stainless steel manufactured by additive manufacturing adopts the following preparation process:
S1, taking powders of stainless steel for later use:
The powder components comprise 0.044 wt % of C, 0.58 wt % of Si, 0.46 wt % of Mn, 14.73 wt % of Cr, 5.01 wt % of Ni, 4.01 wt % of Cu and 0.385 wt % of Nb. The balance composition of the powder is Fe and inevitable impurity elements. The particle size of the powders was 15-45 μm, with an average diameter of 21.81 μm. There was no hollow powder, and the sphericity was more than 95%. No inclusions were detected in the powder and the oxygen content of the powder was 186 ppm;
S2, printing the powder obtained in the step S1 by adopting a 3D printing process to form a printed product:
The diameter of a laser spot of the 3D printing process is 100 μm, the laser power is 230 W, the scanning pitch is 0.10 mm, the scanning speed is 886 mm/s, the powder spreading thickness is 0.02 mm, the protective atmosphere is nitrogen, and the density of the printed product is 98.5%;
S3. heat-treating the printed product formed in step S2:
The heat treatment is carried out in a muffle furnace, the heating rate of the heat treatment is 8° C./min, the temperature is raised to 500° C., and holding for 4 h.

### Embodiment 2

A high-strength and high-ductility stainless steel manufactured by additive manufacturing adopts the following preparation process:
S1, taking powders of stainless steel for later use:
The powder components comprise 0.044 wt % of C, 0.58 wt % of Si, 0.46 wt % of Mn, 14.73 wt % of Cr, 5.01 wt % of Ni, 4.01 wt % of Cu and 0.385 wt % of Nb. The balance composition of the powder is Fe and inevitable impurity elements. The particle size of the powders was 15-45 μm, with an average diameter of 21.81 μm. There was no hollow powders, and the sphericity was more than 95%. No inclusions were detected in the powder and the oxygen content of the powder was 186 ppm;
S2, printing the powder obtained in the step S1 by adopting a 3D printing process to form a printed product:
The diameter of a laser spot of the 3D printing process is 100 μm, the laser power is 260 W, the scanning pitch is 0.10 mm, the scanning speed is 550 mm/s, the powder spreading thickness is 0.02 mm, the protective atmosphere is nitrogen, and the density of the printed product is 99.2%;
S3. heat-treating the printed product formed in step S2:
The heat treatment is carried out in a muffle furnace, the heating rate of the heat treatment is 8° C./min, the temperature is raised to 500° C., and holding for 4 h.

### Embodiment 3

A high-strength and high-ductility stainless steel manufactured by additive manufacturing adopts the following preparation process:
S1, taking powders of stainless steel for later use:
The powder components comprise 0.044 wt % of C, 0.58 wt % of Si, 0.46 wt % of Mn, 14.73 wt % of Cr, 5.01 wt % of Ni, 4.01 wt % of Cu and 0.385 wt % of Nb. The balance composition of the powder is Fe and inevitable impurity elements. The particle size of the powder was 15-45 μm, with an average diameter of 21.81 μm. There was no hollow powders, and the sphericity was more than 95%. No inclusions were detected in the powder and the oxygen content of the powder was 186 ppm;
S2, printing the powder obtained in the step S1 by adopting a 3D printing process to form a printed product:
The diameter of a laser spot of the 3D printing process is 100 μm, the laser power is 260 W, the scanning pitch is 0.10 mm, the scanning speed is 550 mm/s, the powder spreading thickness is 0.02 mm, the protective atmosphere is nitrogen, and the density of the printed product is 99.2%;
S3. heat-treating the printed product formed in step S2:
The heat treatment is carried out in a muffle furnace, the heating rate of the heat treatment is 8° C./min, the temperature is raised to 480° C., and holding for 4 h.

### Embodiment 4

A high-strength and high-ductility stainless steel manufactured by additive manufacturing adopts the following preparation process:
S1, taking powders of stainless steel for later use:
The powder components comprise 0.044 wt % of C, 0.58 wt % of Si, 0.46 wt % of Mn, 14.73 wt % of Cr, 5.01 wt % of Ni, 4.01 wt % of Cu and 0.385 wt % of Nb. The balance composition of the powder is Fe and inevitable impurity elements. The particle size of the powder was 15-45 μm, with an average diameter of 21.81 μm. There were no hollow powders, and the sphericity was more than 95%. No inclusions were detected in the powder and the oxygen content of the powder was 186 ppm;
S2, printing the powder obtained in the step S1 by adopting a 3D printing process to form a printed product:
The diameter of a laser spot of the 3D printing process is 100 μm, the laser power is 260 W, the scanning pitch is 0.10 mm, the scanning speed is 550 mm/s, the powder spreading thickness is 0.02 mm, the protective atmosphere is nitrogen, and the density of the printed product is 99.3%;
S3. heat-treating the printed product formed in step S2:
The heat treatment is carried out in a muffle furnace, the heating rate of the heat treatment is 8° C./min, the temperature is raised to 500° C., and holding for 4 h.

### Comparative Embodiment 1

The difference from embodiment 1 is that comparative embodiment 1 does not perform heat treatment, and the specific process is as follows:
An additive manufacturing high-strength and high-ductility stainless steel adopts the following preparation process:
S1, taking powders of stainless steel for later use:
The powder components comprise 0.044 wt % of C, 0.58 wt % of Si, 0.46 wt % of Mn, 14.73 wt % of Cr, 5.01 wt % of Ni, 4.01 wt % of Cu and 0.385 wt % of Nb. The balance composition of the powder is Fe and unavoidable impurity elements. The particle size of the powders was 15-45 μm, with an average diameter of 21.81 μm. There were no hollow powders, and the sphericity was more than 95%. No inclusions were detected in the powder and the oxygen content of the powder was 186 ppm;
S2, printing the powder obtained in the step S1 by adopting a 3D printing process to form a printed product:
The diameter of a laser spot of the 3D printing process is 100 μm, the laser power is 260 W, the scanning pitch is 0.10 mm, the scanning speed is 550 mm/s, the powder spreading thickness is 0.02 mm, the protective atmosphere is nitrogen, and the density of a printed product is 99.2%.

### Comparative Embodiment 2

Comparative embodiment 2 was manufactured using a conventional smelting and manufacturing process to produce 15-5 PH martensitic stainless steel of similar composition to embodiment 1-4. The peak aging process is used: the heating rate is 8° C./min until the temperature rises to 500° C. and the holding time is 4 h.

### Comparative Embodiment 3

The difference with comparative embodiment 1 is that comparative embodiment 3 has a slight reduction in the alloy composition, especially in Ni and Cu content. The specific process is as follows:
A high-strength and high-ductility stainless steel manufactured by additive manufacturing adopts the following preparation process:
S1, taking powders of stainless steel for later use:

The powder components comprise 0.039 wt % of C, 0.42 wt % of Si, 0.53 wt % of Mn, 14.35 wt % of Cr, 4.39 wt % of Ni, 3.25 wt % of Cu and 0.485 wt % of Nb. The balance composition of the powder is Fe and inevitable impurity elements. The particle size of the powder was 15-45 μm, with an average diameter of 21.81 μm. There were no hollow powders, and the sphericity was more than 95%. No inclusions were detected in the powder and the oxygen content of the powder was 186 ppm;
S2, printing the powder obtained in the step S1 by adopting a 3D printing process to form a printed product:
The diameter of a laser spot of the 3D printing process is 100 μm, the laser power is 260 W, the scanning pitch is 0.10 mm, the scanning speed is 550 mm/s, the powder spreading thickness is 0.02 mm, the protective atmosphere is nitrogen, and the density of the printed product is 99.4%;
S3. heat-treating the printed product formed in step S2:

The heat treatment is carried out in a muffle furnace, the heating rate of the heat
treatment is 8° C./min, the temperature is raised to 480° C., and holding for 4 h.

The stainless steels prepared in the embodiments and comparative embodiments were manufactured and the results of the tensile tests are shown in Table 1.

### Embodiment 1

TABLE 1
The mechanical behaviors of the embodiments and
the comparative embodiments in this invention

| | Yield | Tensile | Elongation after |
|---|---|---|---|
| | strength (MPa) | strength (MPa) | fracture (%) |
| Embodiment 1 | 1310 | 1410 | 16.3 |
| Embodiment 2 | 1325 | 1445 | 16.9 |
| Embodiment 3 | 1330 | 1453 | 15.9 |
| Embodiment 4 | 1270 | 1385 | 16.4 |
| Comparative | 1083 | 1181 | 17.5 |
| Embodiment 1 | | | |
| Comparative | 1170 | 1265 | 12.5 |
| Embodiment 2 | | | |
| Comparative | 1533 | 1648 | 8.6 |
| Embodiment 3 | | | |

Table 1 The tensile tests results of embodiments and comparative embodiments of the invention.

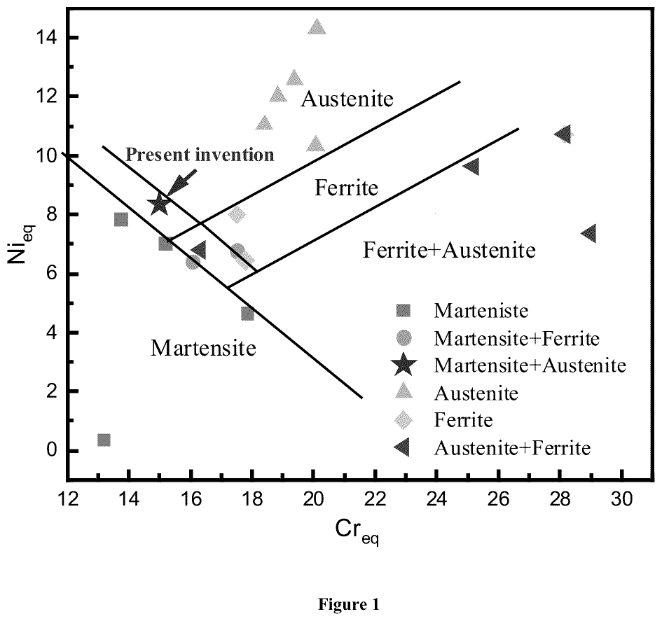

FIG. 1 shows the relationship between the phase composition and the Cr equivalent/Ni equivalent of the additive-manufactured stainless steel. As can be seen from FIG. 1, taking embodiment 1 as an example, the alloy composition of embodiment 1 of the present invention has a Cr equivalent (Cr_{eq}) of 14.999 and a Ni equivalent (Ni_{eq}) of 8.35, with the Cr equivalent and Ni equivalent corresponding to regions located in the martensitic and austenitic dual-phase zones.

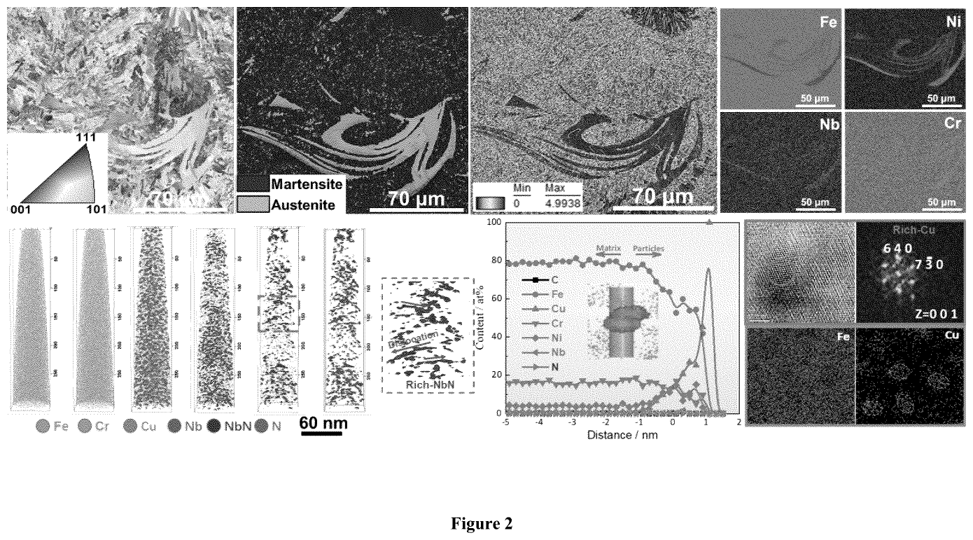

FIG. 2 shows the microstructure of the stainless steel of embodiment 1 in the present invention, from which it can be seen that the microstructure is mainly martensite matrix and has an austenite content of about 25% including bulk austenite (17%) distributed at the bottom of the molten pool and thin film austenite (8%) distributed between the martensite laths.

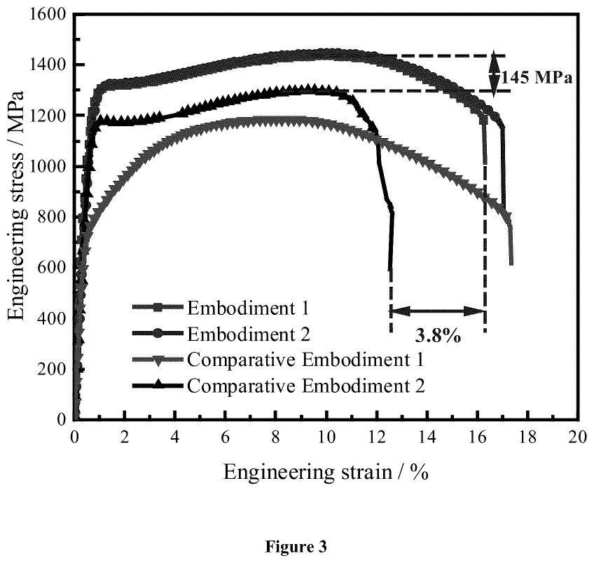

FIG. 3 is the tensile test of stainless steel according to embodiments and comparative embodiments of the present invention at room temperature. As can be seen from FIG. 3, the yield strength of embodiment 1 was 1.31 GPa, which was 140 MPa higher than that of the conventional high-strength martensitic stainless steel (comparative example 2). The tensile strength is 1.41 GPa, which is 145 MPa higher than that of the traditional high-strength martensitic stainless steel (comparative embodiment 2). The elongation after fracture was 16.3%, which was 3.8% higher than that of the conventional high-strength stainless steel (comparative embodiment 2). The additive manufactured heterostructure martensitic stainless steel without heat treatment showed a post fracture elongation of 17.5% for comparative embodiment 1.

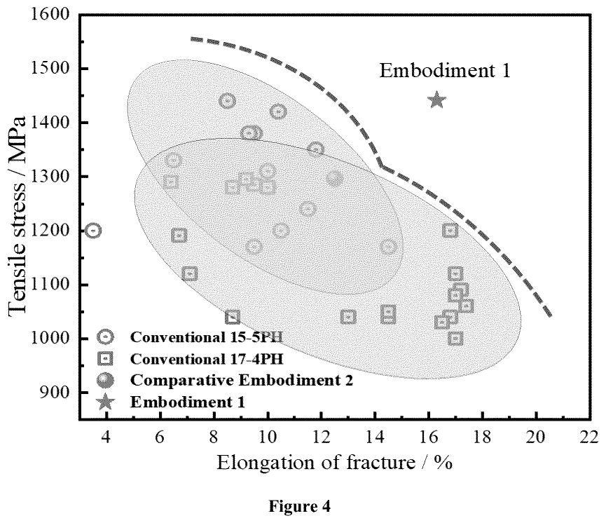

The tensile strength and the elongation after fracture of the traditional martensitic stainless steel with similar compositions are subjected to statistical analysis. And as can be seen from FIG. 4, the strength and the elongation after fracture of the sample in the embodiment 1 are synchronously improved, so that the trade-off between strength and ductility of traditional martensitic stainless steel is broken. The higher strength comes from high-density dislocation and nano-scale multiple precipitated phases in the printing process and the aging treatment. The better plasticity mainly is contributed to the coordinated deformation of high-content heterostructure austenite.

The above description is only a preferred embodiment of the present invention, and is not intended to limit the scope of the present invention, and all equivalent structural changes made by using the content of the present specification or other related technical fields within the spirit of the present invention are included in the scope of the present invention.

What is claimed is:

1. An additively manufactured high-strength and high-ductility stainless steel, characterized in that the composition, by weight percentage, C≤0.05 wt %, Si≤1 wt %, Mn≤1 wt %, Cr 14.5-15.5 wt %, Ni 5.0-5.5 wt %, Cu 4-4.5 wt %, Nb 0.35-0.45 wt %, and the balance of Fe and unavoidable impurities. And Cr equivalent of Cr_{eq}=% Cr+% Mo+2.2% Ti+0.7% Nb+2.48% Al. Ni equivalent of Ni_{eq}=% Ni+35% C+20% N+0.25% Cu. The yield strength of the high-strength and high-ductility stainless steel ≥1270 MPa, the tensile strength ≥1380 MPa, and the elongation after fracture ≥15%.

2. The additively manufactured high-strength and high-ductility stainless steel according to claim 1, characterized in that the microstructure of high-strength and high-ductility stainless steel comprises bulk austenite distributed at the bottom of the molten pool and thin film austenite formed between martensitic laths, with a high density of nanoscale multiple precipitates in the matrix of the fine martensitic laths.

3. The additively manufactured high-strength and high-ductility stainless steel according to claim 1, characterized in that high-strength and high-ductility stainless steel has a yield strength ≥1300 MPa, a tensile strength ≥1440 MPa, and an elongation after fracture ≥16%.

4. A method for preparing high-strength and high-ductility stainless steel for additive manufacturing, characterized in that the method comprises the steps of:
S1, taking the stainless-steel powders of the components for standby;
S2, printing the powder described in the step S1 by adopting a 3D printing process to form a printed product; and
S3, carrying out heat treatment on the printed product formed in the step S2.

5. The method for the preparation of high-strength and high-ductility stainless steel by additive manufacturing according to claim 4, characterized in that in step S1, size of powder particles for the stainless steel is 15-45 μm.

6. The method for the preparation of high-strength and high-ductility stainless steel by additive manufacturing according to claim 4, characterized in that in step S2, the diameter of a laser spot of the 3D printing process is 100-300 μm, the laser power is 230-400 W, the scanning pitch is 0.07-0.10 mm, the scanning speed is 550-900 mm/s, the powder spreading thickness is 0.02-0.04 mm

7. The method for the preparation of high-strength and high-ductility stainless steel by additive manufacturing according to claim 4, characterized in that in step S2, the protective atmosphere for the 3D printing process is nitrogen.

8. The method for the preparation of high-strength and high-ductility stainless steel by additive manufacturing according to claim 4, characterized in that in step S2, the density of printed product is 98.5%.

9. The method for the preparation of high-strength and high-ductility stainless steel by additive manufacturing according to claim 4, characterized in that in step S3, the heating rate of the heat treatment is 6-10° C./min until the temperature rises to 450-500° C., holding for 2-10 h.
